(19) United States
(12) Patent Application Publication
(10) Pub. No.: US 2008/0252557 A1
(43) Pub. Date: Oct. 16, 2008

(54) Plasma display and its method of manufacture

(76) Inventor: Ji-Eun Lee, Suwon-si (KR)

Correspondence Address: ROBERT E. BUSHNELL, 1522 K STREET NW, SUITE 300, WASHINGTON, DC, 20005-1202, US

(21) Appl. No.: 12/076,778

(22) Filed: Mar. 21, 2008

(30) Foreign Application Priority Data
Apr. 12, 2007 (KR) 10-2007-0036008

(51) Int. Cl. G09G 3/10

(52) U.S. Cl. 345/41

(57) ABSTRACT

A plasma display includes: a Plasma Display Panel (PDP), a chassis base having a first surface attached to the PDP; and a printed circuit board assembly arranged on a second surface of the chassis base and electrically connected to the PDP; the chassis base includes a plate portion attached to the PDP, and a boss integrally formed with the plate portion; and the boss includes a pillar portion protruding from the plate portion, and a supporting portion arranged on an upper end of the pillar portion. A method of manufacturing a PDP includes: forming a boss forming portion on a plate portion of a chassis base attached to a Plasma Display Panel (PDP); forming a pillar portion by causing the boss forming portion to protrude away from the PDP through a drawing process; and forming a supporting portion on an end of the pillar portion through a burring process.

### CLAIM OF PRIORITY

This application makes reference to, incorporates the same herein, and claims all benefits accruing under 35 U.S.C. § 119 from an application earlier filed in the Korean Intellectual Property Office on Apr. 12, 2007 and there duly assigned Serial No. 10-2007-0036008.

### BACKGROUND OF THE INVENTION

1. Field of the Invention

The present invention relates to a plasma display and a method of manufacturing the plasma display. More particularly, the present invention relates to a plasma display having a chassis base with an integrally formed boss.

2. Description of the Related Art

A Plasma Display Panel (PDP) is configured to display an image by exciting phosphors using Vacuum UltraViolet (VUV) rays generated by a gas discharge occurring in discharge cells. The PDP has an excellent display capacity, luminance, contrast, and viewing angle.

A plasma display has a PDP, a chassis base supporting and fixing a surface of the PDP, a plurality of Printed Circuit Board Assemblies (PBAs) arranged on a first surface of the chassis base, which is opposite to a second surface of the chassis base facing the PDP, a case enclosing the PDP, chassis base, and PBAs and defining an outer appearance of the plasma display.

The case has a front cover located in the front of the PDP and a rear cover located in the rear of the PDP. The front and rear covers are configured to be assembled and disassembled.

The PBAs mounted on the chassis base include a power supply board assembly, a logic board assembly, an address buffer board assembly, a sustain drive board assembly, and a scan drive board assembly.

Each of the PBAs is formed by mounting driving circuit devices on a Printed Circuit Board (PCB). The PBAs are mounted on bosses provided on the chassis base and fixed by setscrews coupled to the bosses.

The bosses are separately prepared from the chassis base and fixed on the chassis base through a boss coupling process.

As described above, since the chassis base and the bosses are separately prepared and then assembled together, the number of manufacturing processes increases. This causes an increase in the manufacturing costs.

### SUMMARY OF THE INVENTION

An exemplary embodiment of the present invention provides a plasma display that is configured to reduce manufacturing costs, simplify manufacturing processes, and improve productivity by reducing the number of components by integrally forming bosses on a chassis base. An exemplary embodiment of the present invention also provides a method of manufacturing the plasma display.

In an exemplary embodiment, a plasma display includes: a Plasma Display Panel (PDP); a chassis base having a first surface attached to the PDP; and a printed circuit board assembly arranged on a second surface of the chassis base and electrically connected to the PDP; the chassis base includes a plate portion attached to the PDP, and a boss integrally formed with the plate portion; and the boss includes a pillar portion protruding from the plate portion, and a supporting portion arranged on an upper end of the pillar portion.

The pillar portion may be hollow, and the pillar portion may include a threaded inner circumference.

The supporting portion may be formed in parallel with the plate portion, and the supporting portion may be divided into a plurality of sections formed along an outer circumference of the upper end of the pillar portion.

In another exemplary embodiment of the present invention, a method of manufacturing a plasma display includes: forming a boss forming portion on a plate portion of a chassis base attached to a Plasma Display Panel (PDP); forming a pillar portion by causing the boss forming portion to protrude away from the PDP through a drawing process; and forming a supporting portion on an end of the pillar portion through a burring process.

The forming of the boss forming portion may include forming a notch on the plate portion.

The forming of the boss forming portion may include piercing the plate portion.

The method may further include forming a thread portion on an inner circumference of the pillar portion through a tapping process.

According to the above exemplary embodiments, since the bosses integrally protrude from the chassis base, the number of components used for manufacturing the chassis base can be reduced and the manufacturing process can be simplified, thereby reducing the manufacturing costs.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a plasma display according to an exemplary embodiment of the present invention.

FIG. 2 is an enlarged perspective view of a sustain driving board assembly being coupled to a chassis base depicted in FIG. 1.

FIG. 3 is an enlarged perspective view of a boss of the chassis base depicted in FIG. 2.

FIG. 4 is a sectional view taken along line IV-IV of FIG. 3.

FIGS. 5A to 5D are views of a process of integrally forming bosses with a chassis base.

### DETAILED DESCRIPTION OF THE INVENTION

The present invention is described more fully hereinafter with reference to the accompanying drawings, in which exemplary embodiments of the present invention are shown. As those skilled in the art would realize, the described embodiments may be modified in various different ways, all without departing from the spirit or scope of the present invention. In the drawings, portions that are not related to the present invention have been omitted for simplicity. Throughout the drawings, like reference numerals refer to like parts and the like parts have been described in only one exemplary embodiment.

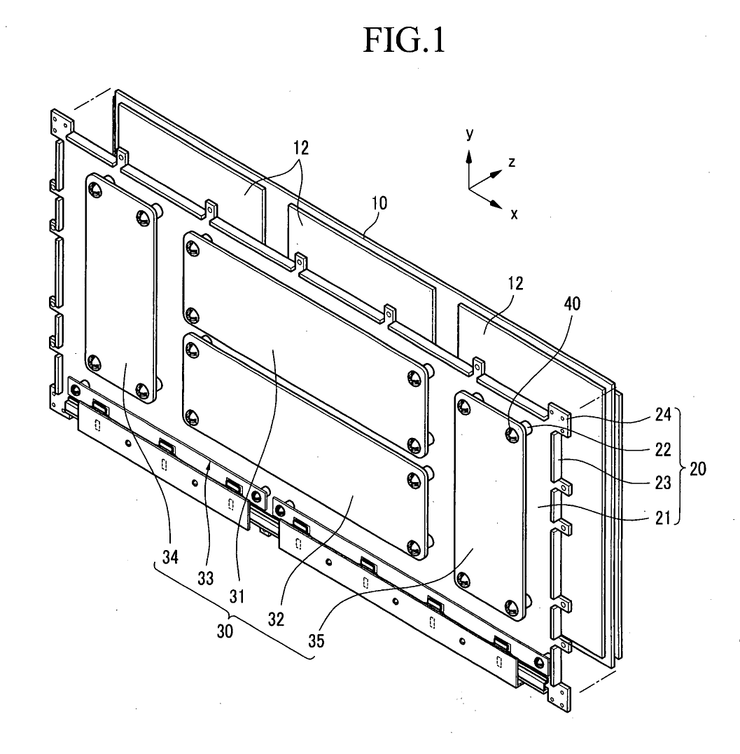

FIG. 1 is an exploded perspective view of a plasma display according to an exemplary embodiment of the present invention.

Referring to FIG. 1, a plasma display includes a PDP 10, a chassis base 20, and printed circuit board assemblies 30. The plasma display 10 further includes a front cover (not shown) disposed on a front surface of the PDP 10 and a rear cover (not shown) disposed on a rear surface of the chassis base 20.

The PDP 10 is formed in a rectangular shape having an x-direction length greater than a y-direction length in FIG. 1. The PDP 10 includes two rectangular substrates that are sealed at their peripheries to define discharge spaces therebetween. The gas discharge occurs in the discharge spaces to realize an image.

The chassis base 20 includes a plate portion 21 that is flat to correspond to a surface of the PDP 10 and integral bosses 22 protruding from the plate portion 21. The bosses 22 are arranged to mount the printed circuit board assemblies 30 on the chassis base 20.

Furthermore, the plate portion 21 of the chassis base 20 is provided with reinforcing portions 23 at an edge thereof, the reinforcing portions 23 being bent along the edge to enhance a bending strength and at respective corners with ear portions 24.

The PDP 10 is attached on a first surface of the plate portion 21 of the chassis base 20 and the bosses 22 are integrally formed on a second surface of the plate portion 21. The printed circuit board assemblies 30 are fixed on the bosses 22.

The PDP 10 is attached to the chassis base 20 by a double-sided adhesive tape (not shown). A thermal conduction sheet 12 may be interposed between the chassis base 20 and the PDP 10. The thermal conduction sheet 12 functions to dissipate heat toward the chassis base 20 by quickly conducting the heat, which is generated during driving of the PDP 10, in a planar direction.

The printed circuit board assemblies 30 are electrically connected to address electrodes, scan electrodes, and sustain electrodes of the PDP 10 through printed circuit boards.

The printed circuit board assemblies 30 include a power supply board assembly 31, a logic board assembly 32, an address buffer board assembly 33, a scan driving board assembly 34, and a sustain driving board assembly 35.

The power supply board assembly 31 supplies a driving voltage, the logic board assembly 32 receives an externally supplied video signal and generates a control signal required for driving.

The address buffer board assembly 33 receives the driving control signal from the logic board assembly 32 and supplies a voltage for selecting discharge cells that will be driven to the address electrode.

Furthermore, the scan driving board assembly 34 and the sustain driving board assembly 35 supply driving signals transmitted from the logic board assembly 32 to the scan and sustain electrodes.

Each of the power supply board assembly 31, the logic board assembly 32, the address buffer board assembly 33, the scan driving board assembly 34, and the sustain driving board assembly 35 includes a printed circuit board on which an electric circuit pattern is printed and a plurality of driving circuit devices mounted on the printed circuit board.

The power supply board assembly 31, the logic board assembly 32, the address buffer board assembly 33, the scan driving board assembly 34, and the sustain driving board assembly 35 are fixed on the integral bosses 22 protruding from the chassis base 20.

The following is a description of the printed circuit board assembly 30 being mounted on the chassis base 20. The sustain driving board assembly 35 is used as an example of the printed circuit board assembly.

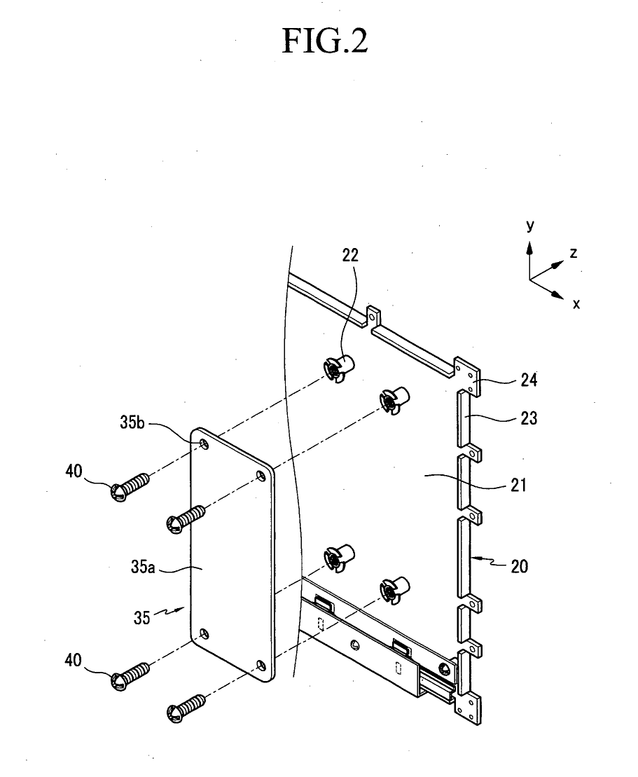

FIG. 2 is a partially enlarged perspective view of the sustain driving board assembly being coupled to the chassis base of FIG. 1.

Referring to FIG. 2, the printed circuit board 35a of the sustain driving board assembly 35 is provided with coupling holes 35b corresponding to the respective bosses 22.

The sustain driving board assembly 35 is fixed by setscrews 40 coupled to the bosses 22 through the coupling hole 35b of the printed circuit board 35a. The sustain driving board assembly 35 is spaced apart from the plate portion 21 of the chassis base 20 by a height of the bosses 22.

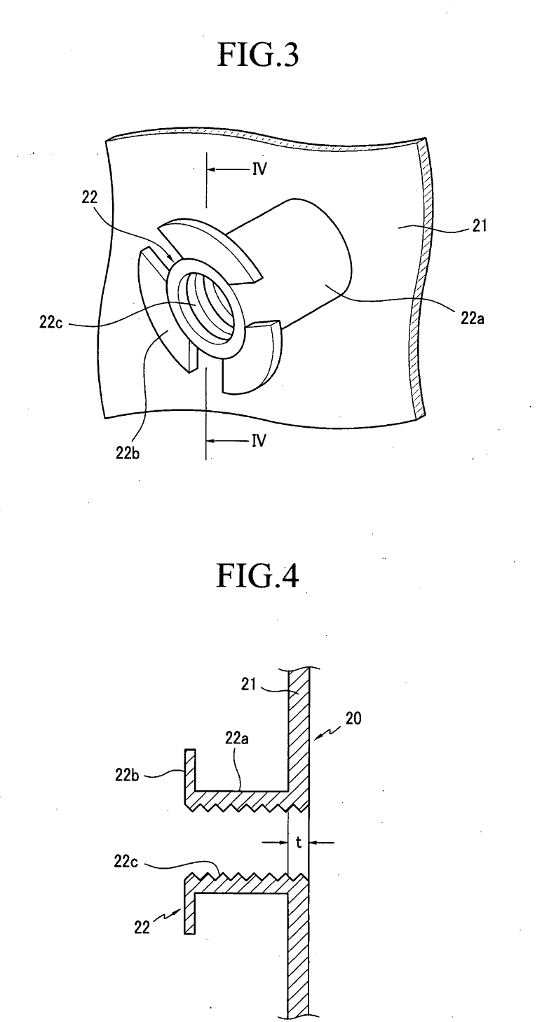

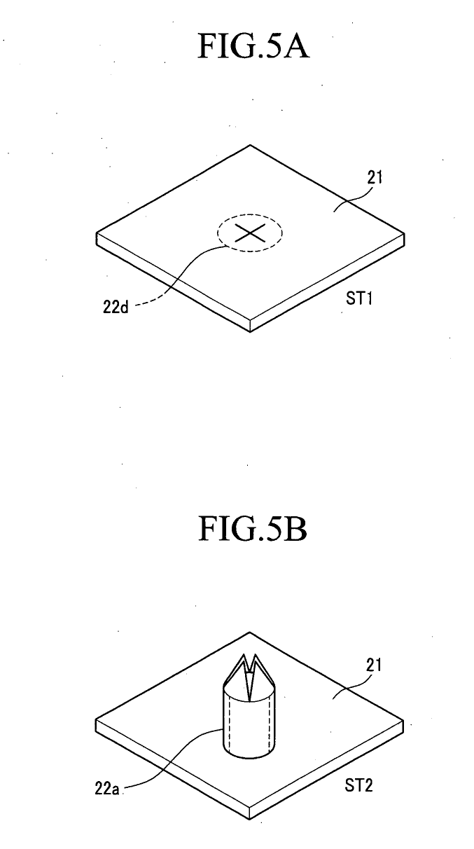

FIG. 3 is an enlarged perspective view of the boss of the chassis base of FIG. 2 and FIG. 4 is a sectional view taken along line IV-IV of FIG. 3.

Referring to FIGS. 3 and 4, the boss 22 includes an integral pillar portion 22a protruding from the plate portion 21 of the chassis base 20 and a supporting portion 22b extending from an outer circumference of an upper end of the pillar portion 22a.

The pillar portion 22a is formed as a hollow tube by penetrating the plate portion 21 of the chassis base 20. A thread portion 22c to receive the setscrew 40 is formed on an inner circumference of the hollow pillar portion 22a.

The supporting portion 22b extends from the outer circumference of the upper end of the pillar portion 22a to support a circumference of the coupling hole formed in the printed circuit board of the printed circuit board assembly 30. Therefore, the supporting portion 22b may extend in parallel with the plate portion 21 of the chassis base 20.

Furthermore, the supporting portion 22b is divided into two or more sections formed along the outer circumference of the upper end of the pillar portion 22a. In the present exemplary embodiment, the supporting portion 22b is divided into three sections formed along the outer circumference of the upper end of the pillar portion 22a.

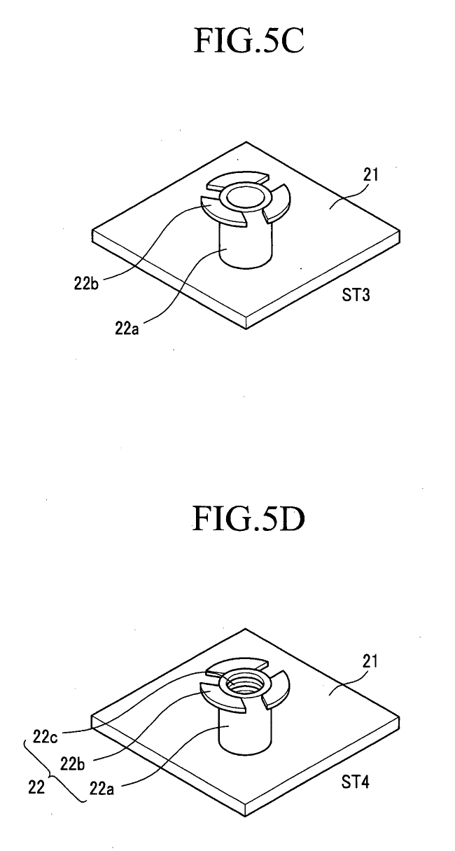

The following will describe a process for integrally forming the bosses on the chassis base with reference to FIGS. 5A to 5D.

FIGS. 5A to 5D are views of a process for integrally forming the bosses on the chassis base.

Referring to FIGS. 5A to 5D, a boss forming portion is first formed on the chassis base 20 (ST1). Next, the pillar portion is formed (ST2) and the supporting portion (ST3), after which the thread portion are formed (ST4).

That is, in Step ST1, a notch is formed on a center of a portion, where the boss will be formed on the plate portion 21 of the chassis base 20, through a notching process, thereby forming the boss forming portion 22d.

At this point, the boss forming portion 22d may be formed by performing a piercing process on the plate portion 21 of the chassis base 20.

The reason for forming the boss forming portion 22d through the notching or piercing process is to make it easy to form the pillar portion 22a through a drawing process and to form the supporting portion 22b on the outer circumference of the upper end of the pillar portion 22a through a burring process.

In Step ST2, the boss forming portion 22d that is notching or piercing-processed is drawing-processed so that the boss forming portion 22d can protrude from the plate portion 21 of the chassis base 20 in a direction facing the printed circuit board assembly 30, thereby forming the pillar portion 22a of the boss 22.

Since the pillar portion 22a of the boss 22 is formed by protruding a portion of the plate portion 21 of the chassis base 20 through the drawing process, the plate portion 21 and the pillar portion 22a of the boss 22 are integrally formed with each other.

Furthermore, due to a characteristic of the drawing process, a hollow pillar portion 22a is formed through the plate portion 21 of the chassis base 20.

In Step ST3, the upper end of the pillar portion 22a of the boss 22 is burring-processed to form the supporting portion 22b on the outer circumference of the upper end of the pillar portion 22a.

As described above, the supporting portion 22b extends from the outer circumference of the upper end of the pillar portion 22a in parallel with the plate portion 21 of the chassis base 20. The supporting portion 22b contacts a circumference of the coupling hole formed on the printed circuit board of the printed circuit board assembly to support the printed circuit board assembly 30.

Since the supporting portion 22b is formed by performing a burring process for the upper end of the pillar portion 22a, the supporting portion 22b may be divided into two or more sections formed along the outer circumference of the upper end of the pillar portion 22a.

Particularly, when a thickness (t in FIG. 4) of the chassis base is reduced 20 to reduce the weight of the plasma display, the supporting portion 22b is designed such that a supporting area of the printed circuit board assembly 30 can be reinforced by a section of the pillar portion 22a and a flatness of the printed circuit board assembly 30 mounted thereon can be maintained.

Furthermore, in Step ST4, the threaded portion 22c to which the setscrew 40 is mated is formed by performing a tapping process for the inner circumference of the hollow pillar portion 22a.

While the present invention has been described in connection with what is presently considered to be a practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A plasma display comprising:
a Plasma Display Panel (PDP);
a chassis base having a first surface attached to the PDP; and
a printed circuit board assembly arranged on a second surface of the chassis base and electrically connected to the PDP;
wherein the chassis base includes a plate portion attached to the PDP, and a boss integrally formed with the plate portion; and
wherein the boss includes a pillar portion protruding from the plate portion, and a supporting portion arranged on an upper end of the pillar portion.

2. The plasma display of claim 1, wherein the pillar portion is hollow.

3. The plasma display of claim 2, wherein an inner circumference of the pillar portion includes a threaded portion.

4. The plasma display of claim 1, wherein the supporting portion is arranged in parallel with the plate portion.

5. The plasma display of claim 1, wherein the supporting portion is divided into a plurality of sections arranged along an outer circumference of the upper end of the pillar portion.

6. A method of manufacturing a plasma display, comprising:
forming a boss forming portion on a plate portion of a chassis base attached to a Plasma Display Panel (PDP);
forming a pillar portion by causing the boss forming portion to protrude away from the PDP through a drawing process; and
forming a supporting portion on an end of the pillar portion through a burring process.

7. The method of claim 6, wherein forming the boss forming portion comprises forming a notch on the plate portion.

8. The method of claim 6, wherein forming the boss forming portion comprises piercing the plate portion.

9. The method of claim 6, further comprising a tapping process to form a threaded portion on an inner circumference of the pillar portion.
